(19) United States
(12) Patent Application Publication
(10) Pub. No.: US 2015/0167476 A1
(43) Pub. Date: Jun. 18, 2015

(54) AIR-COOLED TURBINE ROTOR BLADE FOR A GAS TURBINE

(71) Applicant: Siemens Aktiengesellschaft, Munich (DE)

(72) Inventors: Fathi Ahmad, Kaarst (DE); Nihal Kurt, Dusseldorf (DE)

(73) Assignee: Siemens Aktiengesellschaft, Munich (DE)

(21) Appl. No.: 14/413,357

(22) PCT Filed: Jun. 11, 2013
(86) PCT No.: PCT/EP2013/061952

§ 371 Date: Jan. 7, 2015

(30) Foreign Application Priority Data
Jul. 12, 2012 (DE) 10 2012 212 235.4

(51) Int. Cl. F01D 5/18

(52) U.S. Cl. CPC F01D 5/187; F05D 2230/21

(57) ABSTRACT

A turbine rotor blade for a gas turbine, including a blade root and an adjoining aerodynamically curved airfoil which has a suction-side lateral wall and a pressure-side lateral wall is provided herein. These lateral walls extend in the chord direction from a common leading edge to a trailing edge and in a span direction having a total span from a blade root end to a blade tip end, a coolant duct for guiding a coolant being provided in the airfoil. In order to provide a sufficiently coolable turbine rotor blade of a comparatively small profile thickness, the airfoil, starting from its blade root end, is devoid of cooling ducts as of a span of 75% of the total span, preferably 60% of the total span.

### CROSS REFERENCE TO RELATED APPLICATIONS

This application is the US National Stage of International Application No. PCT/EP2013/061952 filed Jun. 11, 2013, and claims the benefit thereof. The International Application claims the benefit of German Application No. 102012212235.4 filed Jul. 12, 2012. All of the applications are incorporated by reference herein in their entirety.

### FIELD OF INVENTION

The invention relates to an air-cooled turbine rotor blade for a gas turbine, having a blade root and, adjoining the latter, an aerodynamically curved blade airfoil which has a suction-side sidewall and a pressure-side sidewall which extend chordwise from a leading edge to a trailing edge and spanwise with a total span from a blade root-side end to a blade tip-side end, wherein a coolant duct is provided in the blade airfoil for supplying a coolant.

### BACKGROUND OF INVENTION

Such turbine rotor blades are very well known from the comprehensively available prior art. Turbine rotor blades, which are generally produced by casting, are made so as to be hollow, with the aid of casting cores used in the casting process, such that cooling ducts are present internally, through which, in operation, a coolant—in general cooling air—can flow. The coolant provides sufficient cooling of the material of the turbine blade such that the latter can achieve the predetermined and expected service life, in spite of the high ambient temperatures which arise in the surroundings of the turbine blades during operation of a gas turbine.

Currently, the complexity of the internal configuration of the turbine blades is increasing as turbine blades have to withstand ever higher ambient temperatures long-term. In this respect, the cooling ducts are in the meantime diverted multiple times in meandrous fashion. At the same time, turbulators are often also provided on the internal sides of the blade outer walls, in order to increase the transfer of heat from the material of the turbine blade into the cooling air. Once the heat energy has been successfully absorbed from the material of the turbine rotor blade, the cooling air thus heated is expelled either at the trailing edge of the blade airfoil, at the tip of the blade airfoil or also in the region of the leading edge of the blade airfoil, through corresponding openings which may, where relevant, also be configured as film cooling openings, and is mixed with the hot gas stream.

Consequently, the construction of a turbine rotor blade becomes particularly difficult, in particular in the case of thin profiles. Consequently, the wall thicknesses of the blade airfoil and also the cooling ducts provided internally must be configured, by comparison, in the manner of filigree in order to be able to fulfill the requirement of a thin profile. However, thinner cooling duct cross sections lead to thinner casting core wall thicknesses, such that the casting cores are more likely to break during handling and when stocking the casting apparatus.

For this reason, there is a need to propose air-cooled turbine rotor blades which have a comparatively thin profile but which are nonetheless cooled sufficiently and in which the abovementioned drawbacks are avoided.

### SUMMARY OF INVENTION

An object upon which embodiments of the invention are based is achieved with an air-cooled turbine rotor blade according to the features of the independent claim. Advantageous developments of the turbine rotor blade are indicated in the dependent claims, which may be combined with one another in any fashion.

In the case of the turbine rotor blade for a gas turbine having a blade root and, adjoining the latter, an aerodynamically curved blade airfoil which has a suction-side sidewall and a pressure-side sidewall which extend chordwise from a common leading edge to a trailing edge and spanwise with a total span from a blade root-side end to a blade tip-side end, wherein a coolant duct is provided in the blade airfoil for supplying a coolant, according to an embodiment of the invention, it is provided that the blade airfoil is free from coolant ducts from a point at 60% of the total span, preferably from a point at 75% of the total span, as measured from its blade root-side end which corresponds to 0% of the blade airfoil span. The turbine rotor blade is preferably configured in one piece and therefore produced by casting, in one embodiment.

Embodiments of the invention are based on the knowledge that such turbine rotor blades do not in fact need to withstand the highest currently possible hot gas temperatures, but lower temperatures such as may arise in the second or third turbine section of large, static gas turbines, for example. The particular feature of the turbine rotor blade according to an embodiment of the invention is that it can be made to be solid on the tip side, such that only the central region of the blade profile, as seen spanwise, and the root-side region of the blade profile are to be cooled. An embodiment of the invention thus takes into account the knowledge that, as seen spanwise, the hottest temperatures occur in the central region of the span, whereas in the outer rim sections, that is to say on the blade tip side and the blade root side, lower temperatures occur. In this respect, a blade tip-side cooling of the blade airfoil is not necessary, such that this region can be free from coolant ducts. The region free from coolant ducts makes it possible to produce turbine rotor blades having a comparatively thin profile, since this region increases the overall stiffness and strength of the blade airfoil.

Since the coolant is supplied via the root of the turbine rotor blade, the root-side region of the blade airfoil is also quasi cooled, although this need not necessarily be the case.

Since the blade tip-side region of the blade airfoil is free from coolant ducts, no cooling air is expelled at the blade tip. Equally, there is preferably no expulsion of cooling air over the entire trailing edge of the blade airfoil. In other words: a region extending in the profile chord direction upstream of the trailing edge of the blade airfoil is also free from coolant ducts over the entire span of the blade airfoil. This also increases the strength of the blade airfoil, since otherwise-present coolant ducts would weaken the load-bearing cross section at this point.

According to another advantageous configuration, the coolant duct has an inlet, arranged in the blade root, for coolant and at least one coolant outlet, which coolant outlet or outlets is/are also arranged exclusively in the blade root. Embodiments of the invention thus propose an entirely new construction. The cooling air which heats up in the blade airfoil is not introduced, via the blade airfoil, directly into the hot gas stream in the hot gas path of the turbine, but is expelled in a region outside the hot gas path of the gas turbine. This can reduce the temperature gradient of the components which bound the hot gas path, since the temperature of their colder sides can be controlled with the aid of the expelled but preheated cooling air. It is thus for example even possible for the coolant outlet to be arranged on the leading side; it is nonetheless also possible for the cooling air to be expelled from the blade root on the trailing side.

### BRIEF DESCRIPTION OF THE DRAWINGS

Further advantages and features will be described in more detail with reference to an exemplary embodiment.

FIG. 1 shows a turbine rotor blade in longitudinal section.

### DETAILED DESCRIPTION OF INVENTION

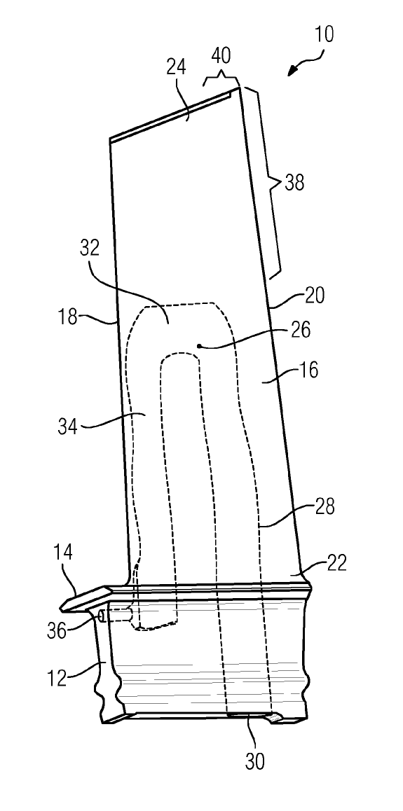

FIG. 1 shows a turbine rotor blade 10 in longitudinal section. The turbine rotor blade 10 is provided for a turbine stage of a static gas turbine, having an intermediate or low degree of cooling. In this respect, the turbine rotor blade 10 can be used in a second, third or fourth turbine stage. The turbine rotor blade 10 has a blade root 12 which is represented at the bottom of FIG. 1. The blade root 12 includes a platform 14 from which there extends, spanwise, a blade airfoil 16. The blade airfoil 16 extends in the direction of the profile chord from a leading edge 18 to a trailing edge 20. During operation, in the case of a turbine blade 10 used in a gas turbine, a hot gas flows around the blade airfoil 16, such that the leading edge 18 and the trailing edge 20 are located respectively on the leading side and the trailing side.

In addition, the blade airfoil 16 has a blade root-side end 22 and a blade tip-side end 24. The average total span is determined from the arithmetic mean of the span at the leading edge 18 and the span at the trailing edge 20 and is normalized to a value of 100%. The origin of the span is arranged at the transition from the platform 14 to the blade root-side end 22 of the blade airfoil 16, such that the total span of 100% is located at the blade tip. The center of the span at 50% of the blade airfoil is provided with the reference sign 26.

The turbine rotor blade 10 is hollow with a single coolant duct 28 which has a blade root-side inlet 30. Downstream of the single diverter section 32, the coolant duct 28 includes a leading edge section 34 whose outlet 36 is arranged, in FIG. 1, beneath the platform 14 and thus in the blade root 12. The turbine rotor blade 10 can be sufficiently stable and strong in spite of a comparatively thin profile, by virtue of a blade tip-side region 38 which is free from coolant ducts and by virtue of a trailing edge region 40 which extends over the entire span and which is also free from coolant ducts. At the same time, the turbine rotor blade is cooled sufficiently to achieve the service life required of it.

Of course, the coolant duct 28 arranged internally may also be formed differently or may also have an outlet 36 on the trailing side. Overall, embodiments of the invention thus relate to a turbine rotor blade 10 for a gas turbine, having a blade root 12 and, adjoining the latter, an aerodynamically curved blade airfoil 16 which has a suction-side sidewall and a pressure-side sidewall which extend chordwise from a common leading edge 18 to a trailing edge 20 and spanwise with a total span from a blade root-side end 22 to a blade tip-side end 24, wherein a coolant duct 28 is provided in the blade airfoil 16 for supplying a coolant. In order to provide a turbine rotor blade 10 which can be cooled sufficiently and which can be equipped with a comparatively thin profile, it is proposed that the blade airfoil 16 is free from coolant ducts from a point at 75% of the total span, preferably 60% of the total span, as measured from its blade root-side end 22.

1. An air-cooled turbine rotor blade for a gas turbine, comprising:
a blade root, and
an aerodynamically curved blade airfoil adjoining the blade root, said curved blade airfoil comprising a suction-side sidewall and a pressure-side sidewall which extend chordwise from a common leading edge to a trailing edge and spanwise with a total span from a blade root-side end to a blade tip-side end, wherein a coolant duct is provided in the blade airfoil for supplying a coolant,
wherein the blade airfoil is free from coolant ducts from a point at 75% of the total span, as measured from its blade root-side end.

2. The turbine rotor blade as claimed in claim 1, wherein said turbine rotor blade is configured in one piece.

3. The turbine rotor blade as claimed in claim 1, wherein the coolant duct has at least one diverter region.

4. The turbine rotor blade as claimed in claim 1, wherein the coolant duct has a blade root-side inlet for coolant and at least one coolant outlet, which wherein said at least one coolant outlet is arranged exclusively on the blade root side.

5. The turbine rotor blade as claimed in claim 1, wherein the at least one coolant outlet is arranged on the leading side.

6. The turbine rotor blade of claim 1, wherein the blade airfoil is free from coolant ducts from a point at 60% of the total span as measured from its blade root-side end.
